(19) United States
(12) Patent Application Publication
(10) Pub. No.: US 2015/0257592 A1
(43) Pub. Date: Sep. 17, 2015

(54) Convertible Grill

(71) Applicant: Hamilton Beach Brands, Inc., Glen Allen, VA (US)

(72) Inventors: Michael Garman, Moseley, VA (US); Paula L. Pennington, Mechanicsville, VA (US); Weiqun Yang, Henrico, VA (US)

(73) Assignee: Hamilton Beach Brands, Inc., Glen Allen, VA (US)

(21) Appl. No.: 14/212,868

(22) Filed: Mar. 14, 2014

(51) Int. Cl. A47J 37/06

(52) U.S. Cl. CPC A47J 37/0676

(57) ABSTRACT

A cooking appliance which includes a lower cooking unit, having a lower cooking surface facing upwards, and an upper cooking unit, having an upper cooking surface. The upper cooking unit is pivotably attached to the lower unit. The upper unit is pivotable between a closed position, wherein the upper cooking surface faces the lower cooking surface, and extends generally parallel thereto, and an open position, wherein the upper cooking surface is oriented at an angle greater than 30 degrees relative to the lower cooking surface. A support member is pivotably attached to the lower unit, and is pivotable between a first position, wherein the support member rests substantially flat against the lower unit, such that the cooking appliance rests level on an underlying surface, and a second position, wherein the support member projects angularly downwardly from the lower unit and onto the underlying surface, thereby inclining the lower cooking surface at an angle relative to the underlying surface.

### FIELD OF THE DISCLOSURE

The present disclosure is directed to an electric cooking appliance, and more particularly to an electric cooking appliance usable as a contact grill, wherein the grill is configurable to either rest flat on the underlying surface or be inclined relative thereto.

### BACKGROUND OF THE DISCLOSURE

Indoor electric grills have become a popular cooking option amongst the consuming public, providing an alternative to outdoor grilling. Typically, indoor electric grills have a lower housing with feet for supporting the grill on a countertop and an upper housing pivotably mounted thereon, and pivotable about a horizontal pivot axis. Both the lower and upper housings support respective upper and lower cooking plates. The upper housing may be oriented in a closed position, atop the lower housing, defining a cooking chamber therebetween, or may be pivoted into an open, griddle position having two upwardly-facing heated cooking plates.

However, there is continuing need to provide indoor electric grills that are increasingly versatile and configurable for different cooking preferences, tasks, and the like. For example, typical electric grills have either a horizontal cooking surface, such that food may cook in its own grease, or angled cooking surfaces, such that liquid, fats, and small food particles that are byproducts of the cooking process may slide or flow down the sloping cooking surface to be drained. In such an angled configuration the food is cooked dry, resulting in crispier and potentially healthier food. However, a user may prefer to sometimes cook certain foods in their own grease, and at other times prefer to cook food dry.

It would be advantageous to manufacture an electric cooking grill that is configurable between one position, wherein at least one of the cooking surfaces is substantially horizontal, minimizing drainage of cooking byproducts, and another position, wherein at least one of the cooking surfaces is inclined, allowing increased drainage of the cooking byproducts, such that the food may be cooked dry.

### BRIEF SUMMARY OF THE DISCLOSURE

Briefly stated, one aspect of the present disclosure is directed to an electric cooking appliance. The electric cooking appliance comprises a lower cooking unit, having a lower cooking surface facing upwards, and an upper cooking unit, having an upper cooking surface, pivotably attached to the lower cooking unit. The upper cooking unit is pivotable between (i) a closed position, wherein the upper cooking surface faces the lower cooking surface, and extends generally parallel thereto, and (ii) an open position, wherein the upper cooking surface is oriented at an angle greater than 30 degrees relative to the lower cooking surface. A support member is pivotably attached to the lower cooking unit, and is pivotable between (I) a first position, wherein the support member rests substantially flat against the lower cooking unit, such that the electric cooking appliance rests level on an underlying surface, and (II) a second position, wherein the support member projects angularly downwardly from the lower cooking unit and onto the underlying surface, thereby inclining the lower cooking surface at an angle relative to the underlying surface.

### BRIEF DESCRIPTION OF THE DRAWINGS

The foregoing summary, as well as the following detailed description of the disclosure, will be better understood when read in conjunction with the appended drawings. For the purpose of illustrating the disclosure, there are shown in the drawings an embodiment which is presently preferred. It should be understood, however, that the disclosure is not limited to the precise arrangements and instrumentalities shown. In the drawings:

FIG. 1 is a front and right side perspective view of an electric cooking appliance according to the present disclosure, with an upper cooking unit thereof in a closed position and a support member thereof in a first position;

FIG. 2 is a front and right side perspective view of the electric cooking appliance of FIG. 1, with the upper cooking unit in an upright position and the support member in the first position;

FIG. 3 is a left side perspective view of the electric cooking appliance of FIG. 1, with the upper cooking unit in a griddle position and the support member in the first position;

FIG. 4 is a front and right side exploded perspective view of the electric cooking appliance of FIG. 1;

FIG. 5 is a bottom and right side perspective view of the electric cooking appliance of FIG. 1, with the upper cooking unit in the closed position and the support member in the first position;

FIG. 6 is a bottom and right side perspective view of the electric cooking appliance of FIG. 1, with the upper cooking unit in the closed position and the support member in a second position;

FIG. 7 right side elevational view of the electric cooking appliance of FIG. 1, with the upper cooking unit in the closed position and the support member in the second position;

FIG. 8 is a partial cross-sectional view of the electric cooking appliance of FIG. 3 along the sectional plane 11-11, showing a lower cooking unit of the appliance, and with the support member in the first position;

FIG. 9 is a cross-sectional view of the electric cooking appliance of FIG. 1 along the sectional plane 9-9, with the upper cooking unit in the closed position and the support member in the first position;

FIG. 10 is a cross-sectional view of the electric cooking appliance of FIG. 2 along the sectional plane 10-10, with the upper cooking unit in the upright position and the support member in the first position;

FIG. 11 is a cross-sectional view of the electric cooking appliance of FIG. 3 along the sectional plane 11-11, with the upper cooking unit in the griddle position and the support member in the first position; and

FIG. 12 is an enlarged partial cross-sectional view of the electric cooking appliance of FIG. 3 along the sectional plane 11-11, showing the upper cooking unit of the appliance in the griddle position and the support member in the second position.

### DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the electric cooking appliance, and designated parts thereof, in accordance with the present disclosure. Unless specifically set forth herein, the terms “a,” “an” and “the” are not limited to one element, but instead should be read as meaning “at least one.” It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit. The terminology includes the words noted above, derivatives thereof and words of similar import.

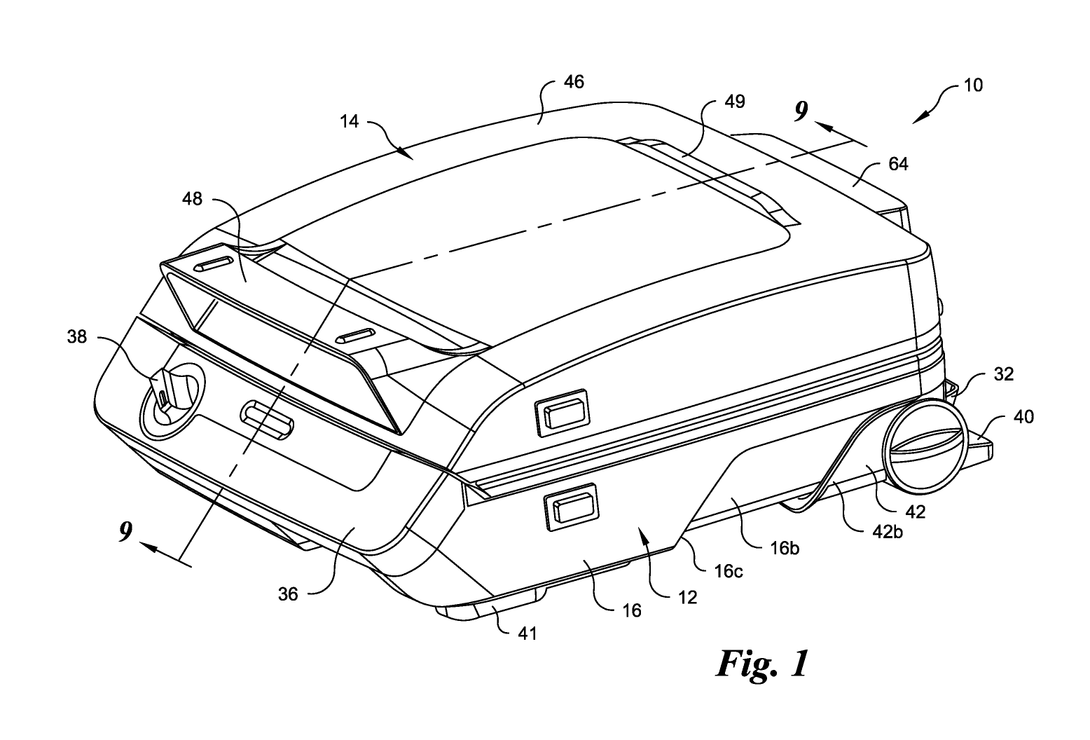

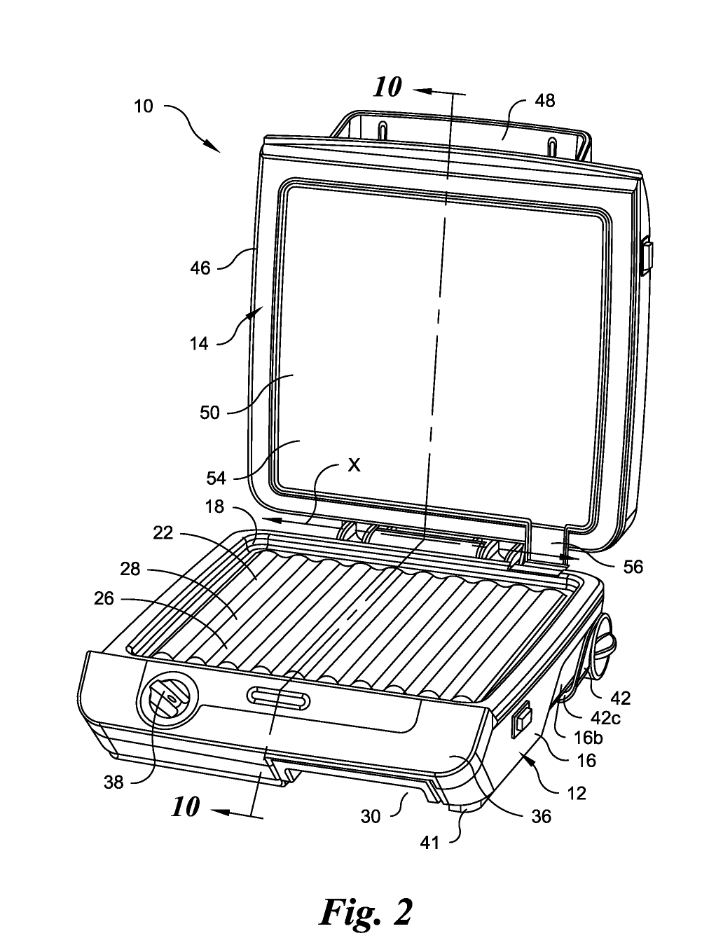

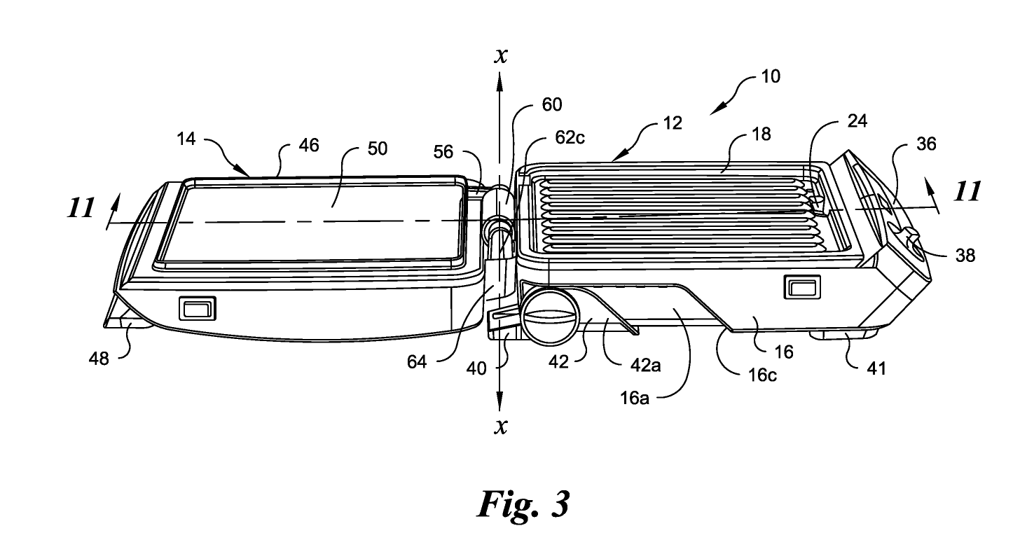

Referring to the drawings in detail, wherein like numerals indicate like elements throughout, there is shown in FIGS. 1-12 an electric cooking appliance, generally designated 10, according to the present disclosure. The electric cooking appliance 10 is illustrated as an electric grill, e.g., for indoor use. As shown in FIG. 1, the electric grill 10 comprises a lower cooking unit 12 and an upper cooking unit 14 pivotally mounted onto the lower cooking unit 12. As will be described further below, the upper cooking unit 14 is pivotable about the horizontal axis X, parallel to the rear ends of the lower and upper cooking units 12, 14, between a closed position (FIG. 1), wherein the upper cooking unit 14 faces the lower cooking unit 12, and an open position, wherein the upper cooking unit 14 is oriented at an angle, preferably an obtuse angle, relative to the lower cooking unit 12. In the open position, the upper cooking unit 14 may be oriented at an upright position (FIG. 2), wherein the upper cooking unit is oriented upright relative to the lower cooking unit 12, and a griddle position (FIG. 3), wherein the upper cooking unit 14 is rotated approximately 180° from the closed position, and is generally in the same plane as the lower cooking unit 12, about the horizontal axis X.

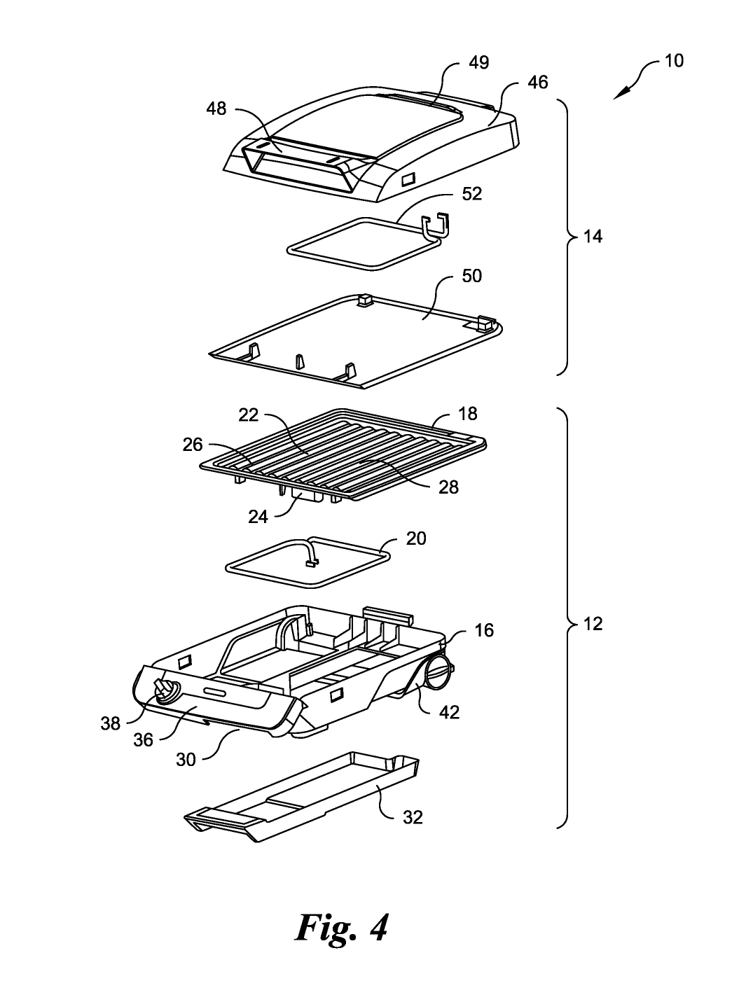

As shown in FIGS. 2 and 4, the lower cooking unit 12 includes a lower housing 16 that supports a lower cooking plate 18 mounted thereon. As should be understood by those of ordinary skill in the art, the lower cooking plate 18 may be made from a suitable aluminum alloy or other suitable metal(s). As also should be understood, the lower cooking plate 18 may include a non-stick coating thereon, such as, for example, without limitation, a Whitford coating. The lower cooking plate 18 may be removably mounted onto the lower housing 12, such that the cooking plate 18 may be either replaced and/or washed separately.

The lower cooking plate 18 is electrically heated via a lower heating element 20, such as, for example, a sheath heater. As should be understood by those of ordinary skill in the art, the heating element 20 is connected to a power source, e.g., a power outlet, via standard power delivery means, such as a power cable (not shown). As shown in FIGS. 2 and 4, the lower cooking plate 18 includes a lower cooking surface 22 and a lower drainage aperture 24 at a front end thereof. In the illustrated embodiment, the lower cooking surface 22 comprises a plurality of parallel and alternating arcuate grooves 26 and arcuate projections 28, defining a “wavy” cooking surface. The arcuate grooves 26 operate to collect liquid cooking byproducts, such as fats, oils and other residues of the cooking process that drip or exude from the food. There is a lower drainage aperture 24, as will be described further below.

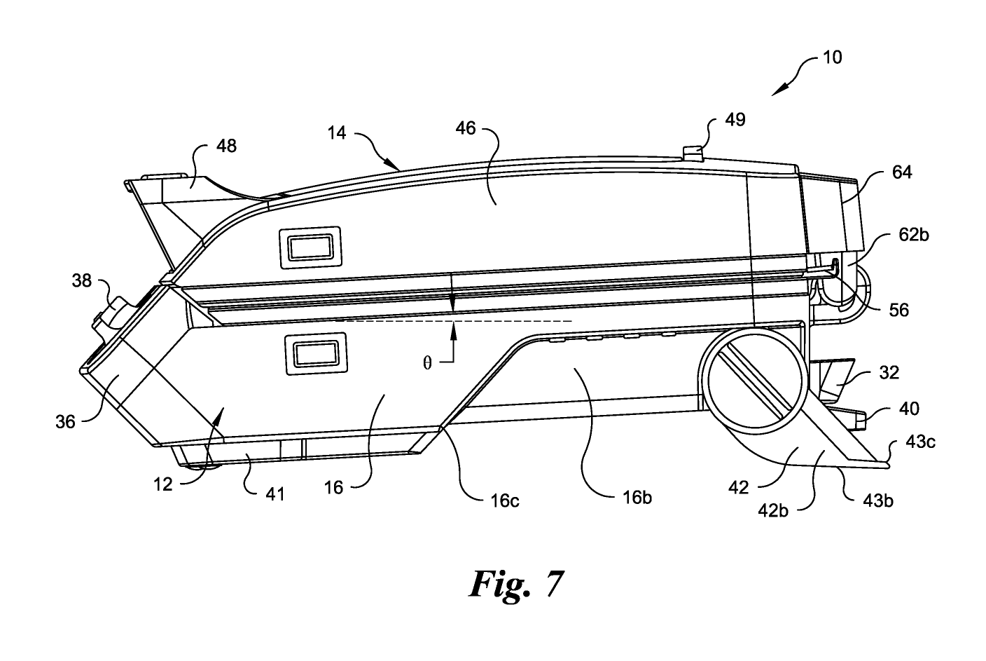

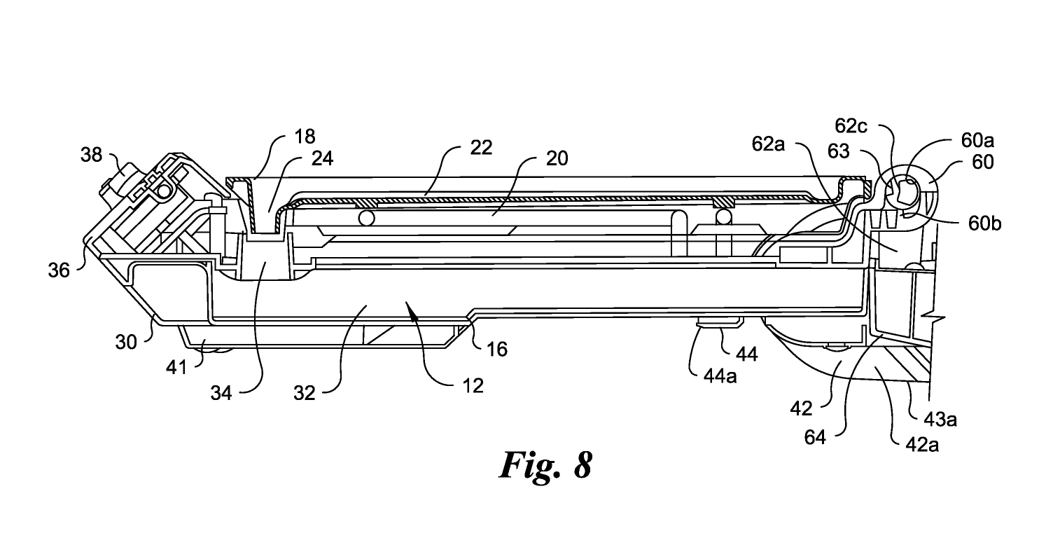

As shown in FIG. 4, the lower housing 16 further includes a cavity 30, located underneath the lower cooking plate 18, for receiving a removable collection tray 32 therein. As shown in FIG. 7, the rear end of the collection tray 32 extends past the rear end of the lower housing 16, thereby exposing a rear portion of the collection tray 32, as will be described further below. As shown best in FIG. 8, a drainage channel 34 extends downwardly in the lower housing 16 between the drainage aperture 24 of the lower cooking plate 18 and the collection tray 32. The collection tray 32 is slidable into and out of the cavity 30 for emptying and cleaning.

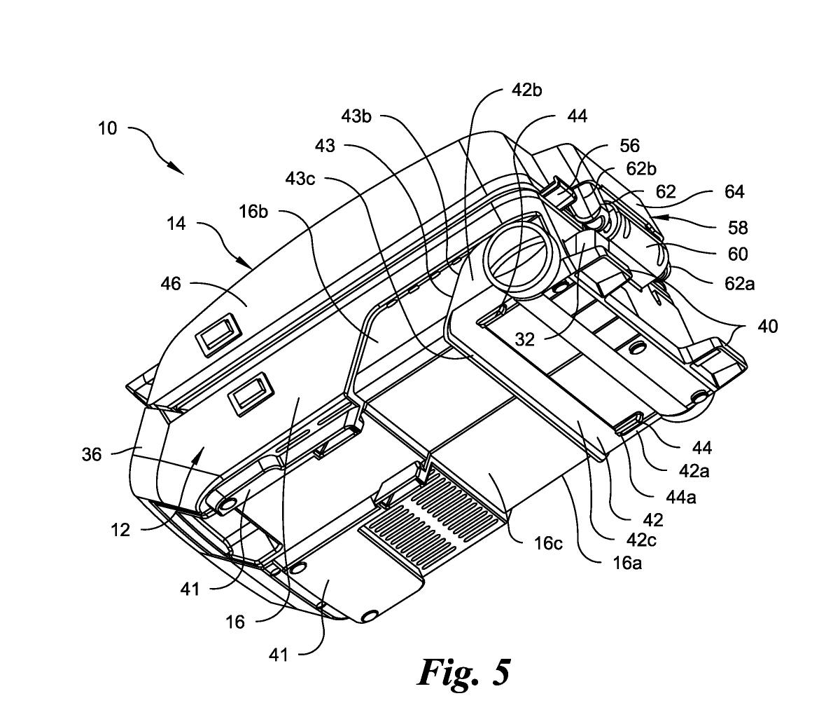

As shown in FIG. 4, the upper cooking unit 14 comprises an upper housing 46, a handle 48 projecting outwardly and generally forwardly from a front end of the housing 46 and a horizontal rib 49 spaced rearwardly of the handle 48 and forwardly from a rear end of the housing 46 and projecting outwardly therefrom. The upper housing 46 secures and supports an upper cooking plate 50. Similarly to the lower cooking plate 18, the upper cooking plate 50 may be removably mounted onto the upper housing 46, such that the cooking plate 50 may be either replaced and/or washed separately. Also similarly, the upper cooking plate 50 may likewise be made from a suitable aluminum alloy or other metal(s) and may also include a non-stick coating thereon. The upper cooking plate 50 is also electrically heated via an upper heating element 52, such as, for example, a sheath heater, the heating element 52 being connected to a power source along with the heating element 20. The upper cooking plate 50 includes an upper cooking surface 54 (FIG. 2), and a drainage ramp 56 (FIG. 5; use of which is described further below) extending from a rear end (when the upper cooking unit 14 is oriented in the closed position) of the cooking plate 50. In the illustrated embodiment, the upper cooking surface 54 is a flat surface. However, the upper cooking surface 54 may alternatively be a “wavy” surface, as explained above with respect to the lower cooking surface 22.

The wavy cooking grids are optimized to cook bacon in that they are substantially less likely to leave grill marks as would occur with a conventional grill plate surface. The wavy construction also ensures a greater surface area of contact to produce crispier bacon. However, the wavy surface treatment for the cooking grids maintains the functionality of a conventional grill plate as far as providing troughs for grease drainage from foods such as burgers, steaks, sausage, etc. A conventional indoor grill, with a tightly spaced troughs and ridges that create grill marks, are not suitable for bacon where it is preferred that the entire slice be cooked uniformly. The wavy pattern as disclosed herein, with approximately or less than 10 ridges and troughs from one side of the plate to the next, optimally cooks bacon while allowing for the subject grill to serve multiple purposes.

Referring now to FIGS. 1 and 2, the lower cooking unit 12 also includes a control panel 36 located at a front end of the lower housing 16. The control panel 36 includes a thermostat knob 38 controlling the temperature of the upper and lower heating elements 52, 20, and thus the cooking temperature. For example, the cooking temperature may be adjusted between about 200° Fahrenheit and about 400° Fahrenheit. As should be understood by those of ordinary skill in the art, the thermostat knob 38 may alternatively take other forms, such as, for example, without limitation, temperature adjustment buttons along with a digital temperature display. As also should be understood, the control panel 36 may further include other cooking control features such as, for example, without limitation, a cooking timer.

As best illustrated in FIGS. 5-7, the lower cooking unit 12 further includes a pair of rear feet 40 projecting rearwardly from the rear end of the lower housing 16. In the illustrated embodiment, the rear feet 40 are projecting rearwardly from opposing sides of the underbody. A pair of front supports 41 extend downwardly from the front end of the lower housing 16. The front supports 41 and the rear feet 40 support the grill 10 on an underlying surface, e.g., a kitchen countertop, when the grill 10 rests level on the underlying surface. The lower cooking unit 12 further includes a support member 42 pivotably connected to the lower housing 16. As shown in FIGS. 5-7, the support member 42 comprises a first, or left, arm 42a pivotably attached to a first, or left, side of the lower housing 16 and a second, or right, arm 42b pivotably attached to a second, or right, side of the lower housing 16, and a center arm 42c (FIG. 5), extending horizontally, i.e., in the direction of the horizontal axis X, between the first and second arms 42a, 42b. As shown, the first and second arms 42a, 42b, define angled leading ends 43a, 43b, respectively. In the illustrated embodiment, the leading ends 43a, 43b extend slightly past the center arm 42, creating a ledge 43c extending therebetween. As should be understood by those of ordinary skill in the art, the first and second arms 42a, 42b, may be pivotably attached to the lower housing 16 via any of numerous different pivoting attachment means currently known, or that later become known.

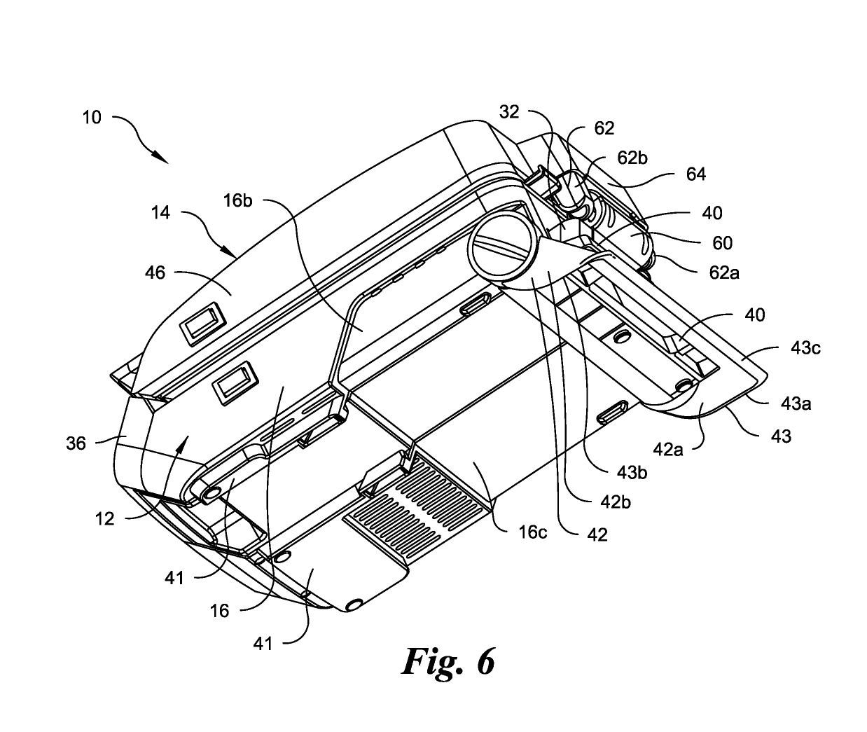

The support member 42 is pivotable relative to the lower housing 16 between a first position, as shown in FIG. 5, and a second position, as shown in FIGS. 6 and 7. The lower housing 16 includes indents 16a, 16b, and 16c in the first, second and underbody sides of the housing, respectively, for accommodating the first, second and center arms 42a, 42b, 42c, respectively, in the first position. In the first position (FIG. 5), the first and second side arms 42a, 42b, rest substantially flat within the first and second indents 16a, 16b, of the lower housing, and the center arm 42c of the support member 42 extends along the indent 16c, across, and rests substantially flat against, the underbody of the lower housing 16. The height of the ledge 43c is substantially equivalent to the depth of the indent 16c, such that when the support member 42 is in the first position, the grill 10 may rest substantially level on an underlying surface, via the front supports 41 and the rear feet 40, without interference from any portion of the support member 42.

As shown in FIGS. 5, 6 and 9, the lower cooking unit 12 may further includes a pair of latches 44 projecting from the underside of the lower housing 16. The latches 44 include respective tapered tabs 44a extending forwardly and substantially perpendicularly from the underside of the latches 44. The latches 44 are positioned on the underside of the lower housing 16, within the indent 16c, such that the rear edge of the center arm 42c of the support member 42 snaps over the tapered tabs 44a to be frictionally interlocking in the first position, thereby releasably holding the support member 42 in the first position. A user disengages the support member 42 from the latches 44, to pivot the support member 42 into the second position, by pulling the support member 42 away from the underside of the lower housing 16 with sufficient force to detach the support member 42 therefrom. As should be understood by those of ordinary skill in the art, however, the support member 42 may alternatively be releasably held in the first position via any of numerous different releasable fixing means, currently known or that later become known, such as, for example, without limitation, a biasing means, e.g., a spring, biasing the support member 42 into the first position, or a mating connection between the support member 42 and the lower housing 16.

In the second position (FIGS. 6, 7), the support member 42 is pivoted away from the first position and the center arm 42c is engaged with the rear feet 40. That is, the support member 42 is pivotable relative the lower housing 16, away from the first position, until the center arm 42c contacts the rear feet 40. In the second position, the support member 42 projects angularly downwardly from the underbody of the lower housing 16, and the leading ends 43a, 43b of the first and second arms 42a, 42b and the ledge 43c rests substantially flat against the surface underlying the grill 10. In the second position the support member 42 inclines the lower cooking unit 12 an angle relative to the underlying surface, thereby also inclining the lower cooking surface 22. In the second position, the angle is within the range of about 2° to about 5°, and preferably about 3°. The rear feet 40 obstruct the support member 42 from pivoting further away from the first position, past the second position.

As shown in FIGS. 5-7, the upper cooking unit 14 is pivotably mounted onto the lower cooking unit 12 via hinge mechanism 58. The hinge mechanism 58 comprises a lower hinge member 60 attached to the rear end of the lower housing 16 and an upper hinge member 62 attached to the rear end of the upper housing 46. The lower hinge member 60 comprises a substantially cylindrically shaped member extending along the horizontal axis X, adjacent the rear end of lower housing 16, and having a hollow interior 60a (FIGS. 8-11). The upper hinge member 62 includes first, or left, and second, or right, spaced apart side arms 62a, 62b, extending downwardly from the rear end of the upper housing 46, and a center arm 62c extending between the lower ends thereof. The first and second side arms 62a, 62b are spaced apart to receive the lower hinge member 60 therebetween, and the center arm 62c extends through the hollow interior 60a of the lower hinge member 60.

As shown in FIGS. 5-7, the upper housing 46 includes a rear hood 64 projecting from the rear end thereof. The first and second side arms 62a, 62b of the upper hinge member 62 are slidably secured within the rear hood 64. That is, the side arms 62a, 62b may translate vertically within the hood 64, but are not removable therefrom. Such vertical translation allows the entire upper cooking unit 14 to have some vertical float, relative to the lower cooking 12, as will be described further below. As should be understood by those of ordinary skill in the art, the side arms 62a, 62b may be slidably secured within the rear hood 64 via any of numerous different attachment means, currently known, or that later become known, such as, for example, without limitation, via a male and female slidable connection in conjunction with complementary shoulders and ribs to prevent disengagement.

As shown in FIG. 8-11, the hollow interior 60a of the lower hinge member 60 has a substantially oval/track-shaped cross-section, i.e., substantially straight, parallel sides and opposing semi-circular ends, and a bump stop 60b extending into the bottom of the hollow interior 60a. The center arm 62c of the upper hinge member 62 has a circular cross-section dimensioned such that the center arm 62c is rotatable within the hollow interior 60a of the lower hinge member 60, as well as vertically translatable upwards and downwards. The center arm 62c also includes a groove 63, extending the entire length of the arm 62c, having a complementary shape to the bump stop 60b.

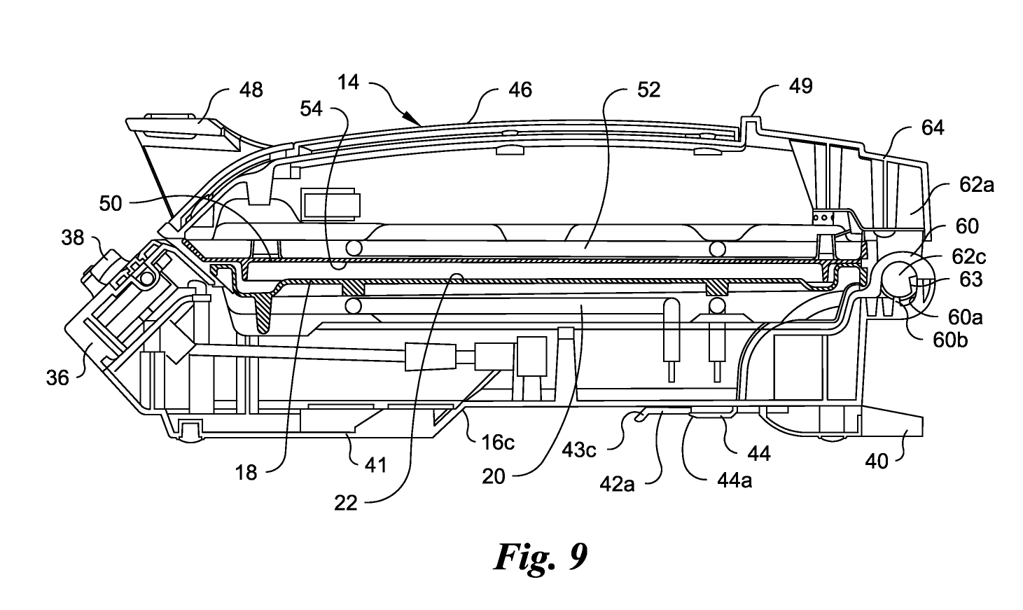

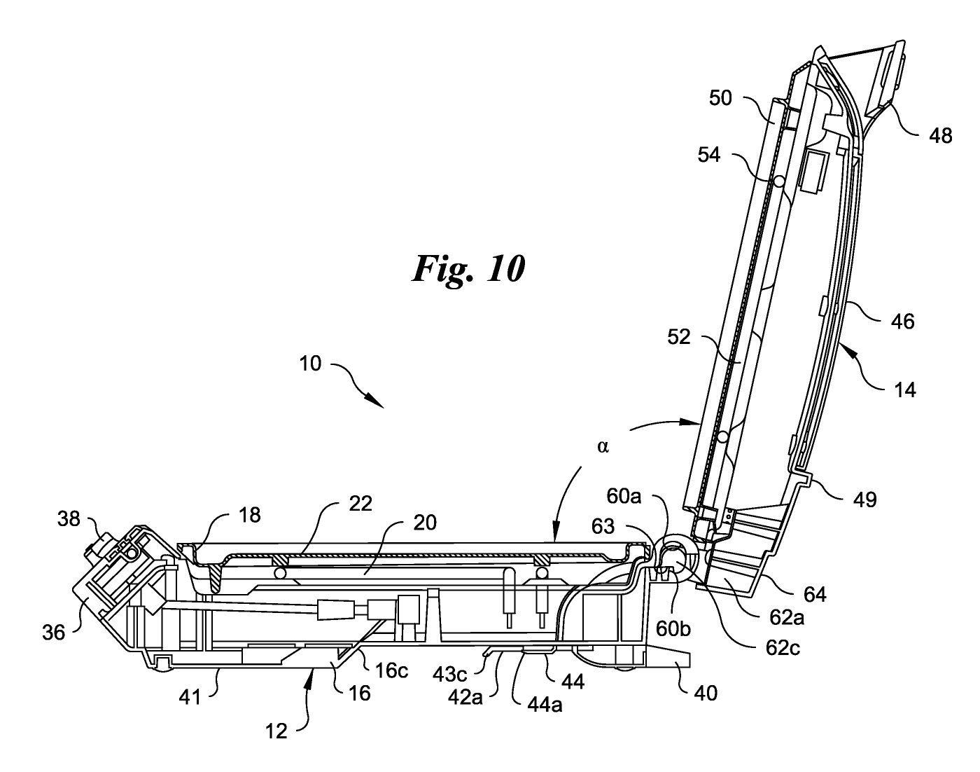

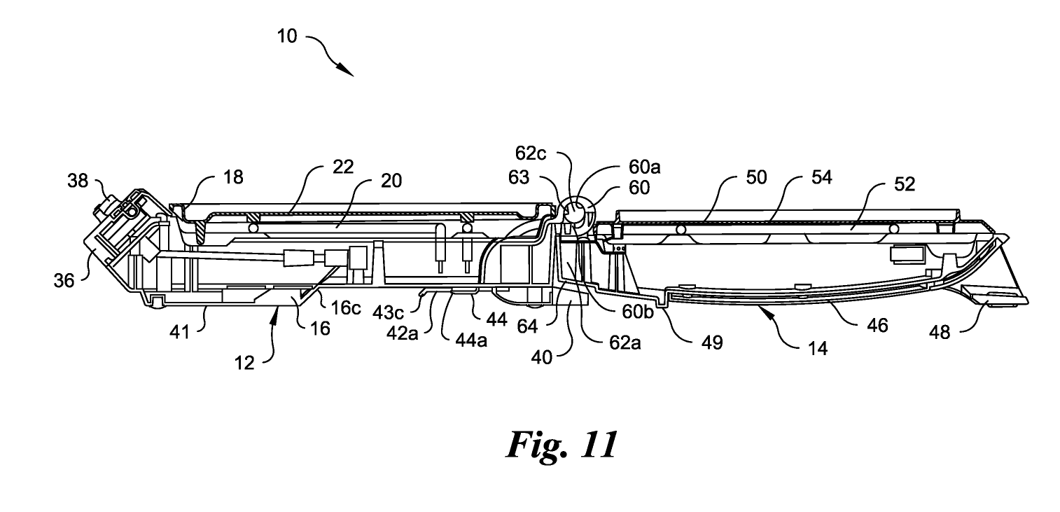

As shown in FIGS. 8 and 9, the center arm 62c, extending through the hollow interior 60a of the lower hinge member 60, rests atop the bump stop 60b when the upper cooking unit 14 is in the closed position (and in the open, griddle position, FIG. 11). To orient the upper cooking unit 14 into the open, upright position (FIG. 10), the upper cooking unit 14 is pivoted upwards, about the horizontal axis X, away from the lower cooking unit 12. As the upper cooking unit 14 pivots, the center arm 62c of the upper hinge member 62 rotates clockwise, thereby rotating the groove 63 toward the bump stop 60b. As shown in FIG. 10, the groove 63 is oriented such that it engages the bump stop 60b when the upper cooking unit 14 reaches the upright position. Once the groove 63 aligns with the bump stop 60b, the groove 63 complementarily receives and engages the bump stop 60b (FIG. 10). To receive the bump stop 60b, the center arm 62c drops vertically deeper within the hollow interior 60a. As shown, the complementary engagement of bump stop 60b with the groove 63 prevents further pivoting of the upper cooking unit 14 away from the lower cooking unit 12, and stabilizes the upper cooking unit 14 in the open, upright position. In the open, upright position, the upper cooking unit 14 is oriented at an obtuse angle a relative to the lower cooking unit 12. When the groove 63 is complementarily engaged with the bump stop 60b, the upper cooking unit 14 and the lower cooking unit 12 are positioned at the angle a and it substantially prevents the upper cooking unit 14 from freely pivoting/falling back toward the lower cooking unit 12. In the open, upright position, the upper cooking unit 14 the angle α is within the range of about 100° to about 105°, and preferably about 102°.

To orient the upper cooking unit 14 into the open, griddle position, as shown in FIG. 11, the upper cooking unit 14 is lifted upwards, such that center arm 62c of the upper hinge member 62 translates vertically upwards within the oval/track-shaped hollow interior 60a of the lower hinge member 60 and the groove 63 clears the bump stop 60b, thereby allowing the center arm 62c to continue rotating clockwise, and the upper cooking unit 14 to pivot further away from the lower cooking unit 12 and into the open, griddle position. In the griddle position, the handle 48 and the rib 49 support the upper cooking unit 14 on the underlying surface, as shown in FIG. 11. In the griddle position, both the lower cooking plate 18 and the upper cooking plate 50 are facing upwardly, thereby providing added surface area for cooking.

In use, the grill 10 is configurable into several different orientations, providing different cooking styles. In one configuration, food may be cooked in the grill 10 with the support member 42 in the first position, i.e., tucked in underneath the grill 10, and the upper cooking unit 14 in the closed position. In such a configuration, food is sandwiched between the lower cooking plate 18 and the upper cooking plate 50. Because the upper hinge member 62 is slidably secured to the upper housing 46, the distance between the upper cooking unit 14 and the lower cooking 12 is adjustable to accommodate different cooking plates and/or food of varying thickness. When the support member 42 is in the first position, the lower cooking plate 18 is either substantially horizontal (when the grill is placed on a level underlying surface) or at relatively small default slope angle to produce minimal drainage. Accordingly, there is minimized drainage of cooking residue, and the food is largely cooked in its own grease. Alternatively, a user may pivot the support member 42 from the first position, to the second position, thereby inclining/tilting (or “further inclining/tilting” in the case embodiment where there is a small default slope angle) the lower cooking plate 18. In such a configuration, liquid cooking byproducts travel under the force of gravity down the respective drainage grooves 26 toward, and, in turn, through the drainage aperture 24, and drip down the drainage channel 34 and into the collection tray 32. In such a configuration, the food will be cooked in more dry scenario and therefore will be crispy. Additionally, draining the grease will ostensibly result in healthier food.

In either the first or second positions of the support member 42, the upper cooking unit 14 may be pivoted from the closed position, to the open, upright position (FIGS. 2 and 10). A user may wish to orient the upper cooking unit 14 into the upright position to assess whether the food has been cooked as desired. Alternatively, a user may wish to solely cook the food from one side, or from one side at a time, and therefore wish to maintain the upper cooking unit 14 in the open, upright position during cooking. A user will know that the upper cooking unit 14 is in the stable upright position, when the groove 63 of the center arm 62c of the upper hinge member 62 rotationally aligns with the bump stop 60b of the lower hinge member 60, such that the center arm 62c drops vertically deeper within the hollow interior 60a, the groove 63 complementarily engages the bump stop 60b, and the upper cooking unit 14 is stopped from pivoting further away from the lower cooking unit 12.

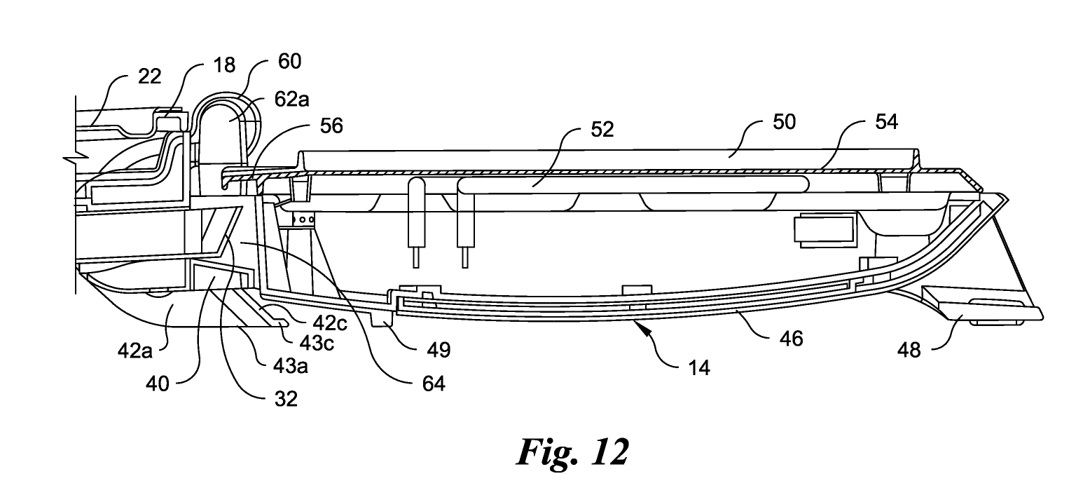

In yet another configuration, the upper cooking unit 14 may be further pivoted into the open, griddle position (FIGS. 3 and 11) with the support member 42 in either of the first or second positions. A user may wish to orient the upper cooking unit 14 into the griddle position to have additional cooking surfaces. To pivot the upper cooking unit 14 into the griddle position, the upper cooking unit 14 is lifted vertically upwardly, such that the center arms 62c, and thus the groove 63, translate upwardly within the track-shaped hollow interior 60a. In such orientation the groove 62 clears the bump stop 60b, thereby allowing the upper cooking unit 14 to rotate clockwise past the upright position, away from the lower cooking unit 12, and into the griddle position. As shown in FIG. 12, if the support member 42 is in the second position when the upper cooking unit 14 is rotated into the open, griddle position, the side arms 62a, 62b of the upper hinge member 62 will slide outwardly from the rear hood 64, such that both the handle 48 and the rib 49 may still contact the underlying surface and support the upper cooking unit 14 to rest in a level orientation. As shown in FIG. 12, the drainage ramp 56 is downwardly inclined from the inner end of the upper cooking surface 54 and is oriented vertically above the portion of the collection tray 32 extending past the rear end of the lower housing 16. Accordingly, liquid cooking byproducts from food cooked on the upper cooking plate 50 may drain down the drainage ramp 62 and drip into the back of the collection tray 32.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

We claim:

1. An electric cooking appliance comprising:
a lower cooking unit, having a lower cooking surface facing upwards;
an upper cooking unit, having an upper cooking surface, pivotably attached to the lower cooking unit, and pivotable between (i) a closed position, wherein the upper cooking surface faces the lower cooking surface, and extends generally parallel thereto, and (ii) an open position, wherein the upper cooking surface is oriented at an angle greater than 30 degrees relative to the lower cooking surface; and
a support member pivotably attached to the lower cooking unit, and pivotable between (I) a first position, wherein the support member rests substantially flat against the lower cooking unit, such that the electric cooking appliance rests level on an underlying surface, and (II) a second position, wherein the support member projects angularly downwardly from the lower cooking unit and onto the underlying surface, thereby inclining the lower cooking surface at an angle relative to the underlying surface.

2. The electric cooking appliance of claim 1, wherein, in the second position, the support member inclines the lower cooking surface within a range of about 2° to about 5° relative to the underlying surface.

3. The electric cooking appliance of claim 1, wherein the support member comprises a first arm pivotably attached to a first side of the lower cooking unit, a second arm pivotably attached to a second side of the lower cooking unit and a center arm extending therebetween.

4. The electric cooking appliance of claim 3, wherein the lower cooking unit comprises a first-indent in the first side thereof for accommodating the first arm of the support member in the first position, a second-indent in the second side thereof for accommodating the second arm of the support member in the first position, and a center-indent in an underside thereof for accommodating the center arm of the support member in the first position, wherein each of the first, second and center arms of the support member rest substantially flat along the respective indent in the first position.

5. The electric cooking appliance of claim 3, wherein the first and second arms of the support member define respective angled leading ends, angled to rest substantially flat against the underlying surface in the second position.

6. The electric cooking appliance of claim 1, wherein the lower cooking unit comprises a lower housing supporting a lower cooking plate, including the lower cooking surface, removably mounted thereon, a lower heating element for heating the lower cooking plate, and the upper cooking unit comprises an upper housing supporting an upper cooking plate, including the upper cooking surface, removably mounted thereon, and an upper heating element for heating the upper cooking plate.

7. The electric cooking appliance of claim of claim 6, wherein the lower cooking surface includes a lower drainage aperture at a front end thereof, and the lower cooking unit further comprises a cavity located underneath the lower cooking plate, a removable collection tray receivable therein and a drainage channel extending between the lower drainage aperture and the collection tray.

8. The electric cooking appliance of claim 7, wherein the lower cooking surface comprises a plurality of parallel and alternating arcuate grooves and arcuate projections.

9. The electric cooking appliance of claim 8, wherein the arcuate grooves and arcuate projections comprise less than 10 grooves and 10 projections in a wavy pattern.

10. The electric cooking appliance of 6, wherein the upper cooking surface includes a drainage ramp extending from a rear end thereof.

11. The electric cooking appliance of claim 6, wherein the lower cooking unit further comprises a control panel located at a front end of the lower housing, controlling temperature of the upper and lower heating elements.

12. The electric cooking appliance of claim 6, wherein the lower cooking unit further comprises a pair of front supports extending downwardly from a front end of the lower housing and a pair of rear feet projecting downwardly and rearwardly from a rear end of the lower housing for supporting the electric cooking appliance on the underlying surface.

13. The electric cooking appliance of claim 12, wherein the support member engages the rear feet in the second position, thereby stabilizing the support member in the second position.

14. The electric cooking appliance of claim 6, wherein the upper cooking unit further comprises a handle projecting outwardly from a front end of the upper housing and a rib spaced rearwardly of the handle and forwardly from a rear end of the upper housing and projecting outwardly therefrom, said handle and rib configured to support the upper cooking unit to rest level on the underlying surface in the open position.

15. The electric cooking appliance of claim 1, wherein the angle of the upper cooking surface relative to the lower cooking surface in the open position is within the range of about 100° to about 105°.

16. The electric cooking appliance of claim 1 wherein the angle of the upper cooking surface to the lower cooking surface is obtuse.

17. The electric cooking appliance of claim 6, further comprising a pair of latches projecting from an underside of the lower housing configured to releasably hold the support member in the first position.
